(19) United States
(12) Patent Application Publication
(10) Pub. No.: US 2008/0103785 A1
(43) Pub. Date: May 1, 2008

(54) SYSTEM AND METHOD FOR PROVIDING EXTENDED WARRANTY PRICING

(76) Inventor: Lester L. Logan, Berea, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/553,234

(22) Filed: Oct. 26, 2006

(51) Int. Cl. G06Q 10/00; G06Q 30/00

(52) U.S. Cl. 705/1

(57) ABSTRACT

A method and system for quoting a purchase price for a vehicle warranty includes obtaining vehicle characteristic data based on a vehicle characteristic identifier; automatically decoding the vehicle characteristic data to determine a vehicle configuration and/or a vehicle status; and quoting a purchase price of a warranty plan based on the vehicle configuration and/or the vehicle status.

### TECHNICAL FIELD OF THE INVENTION

The present invention relates generally to extended warranties and, more particularly, to a system and method for quoting a purchase price of an extended warranty plan.

### DESCRIPTION OF THE RELATED ART

Most vehicles sold today include a manufacturer's warranty. These warranties typically include a predetermined coverage plan that is in effect for a predetermined period (usually expressed in time and/or use). For example, many manufacturers warrant their vehicles under what is known as a bumper-to-bumper warranty. Under a bumper-to-bumper warranty, the cost associated with repairing the vehicle (e.g., component cost and labor cost) is covered by the manufacturer, without any out-of-pocket expense incurred by the vehicle owner. Typically, a bumper-to-bumper warranty is in effect for a set time period and/or set use (e.g., 3 years or 36,000 miles, which ever occurs first).

Some manufactures include an additional warranty that extends past the initial bumper-to-bumper warranty period. This extended warranty period, however, may include only select components of the vehicle. For example, after the initial bumper-to-bumper warranty expires, the automobiles major components (e.g., engine and drive train) maybe warranted for an additional term period (e.g., 10 years or 100,000 miles, which ever occurs first).

Regardless of the type of warranty offered by the manufacturer, once the warranty expires, the vehicle owner has the burden of paying for all repairs. Considering the level of sophistication on modern vehicles, even minor repairs can result in significant costs.

To minimize risks associated potential vehicle repairs, extended warranty plans may be offered to the vehicle purchaser/owner. An extended warranty, as is well known, provides protection against vehicle repair costs after the manufacturer's warranty expires. These extended warranty plans usually are offered at the time the vehicle is new, but also may be offered at a later time. Extended warranty plans for used vehicles typically are subject to certain constraints imposed by the warranty provider (e.g., certain limitations on the age or mileage of the vehicle).

A drawback with conventional extended warranty plans is that determination of a purchase price for the warranty plan can be tedious and time consuming. For example, in determining a cost of the warranty plan, a sales representative first discusses with a potential purchaser the available plans. This can include, for example, explanation of the different warranty options (e.g., the warranty time period), deductibles (e.g., what the purchaser can expect to pay in the event repairs are needed), coverage (e.g., what components are or are not covered under the warranty), etc. Further, the sales representative will obtain information regarding the vehicle that will be covered by the warranty. This information can include, for example, the year, make and model of the vehicle, installed options, and/or current mileage. Other information also may be collected by the sales representative.

Based on the collected information, the sales representative then analyzes the data to arrive at cost for the extended warranty. The analysis may include reviewing numerous documents to obtain expected failure rates and repair costs for the particular vehicle. As will be appreciated, this process can be time consuming. Moreover, often the potential purchaser would like to compare the costs for various protection levels and, thus, the sales representative will need to calculate the costs for several different plans. Once the expected cost of the warranty is calculated, the sales representative informs the potential purchaser of the cost, who then makes a decision as to whether or not to buy the extended warranty.

### SUMMARY

The present invention provides a system and method that enables a purchase price of an extended warranty plan, such as an extended automobile warranty plan, for example, to be quickly and accurately quoted. The estimated purchase price of the extended warranty may be determined by decoding a characteristic identifier associated with the vehicle. For example, in the case of an extended automobile warranty, the characteristic identifier may be a vehicle identification number (VIN), wherein the VIN can be used to obtain data characteristic of the vehicle. The information then can be decoded into meaningful data (e.g., vehicle make and model, year, body style, upgrades, performance packages, etc.), which then can be compared to statistical information regarding failure rates and repair costs. From the statistical data and repair costs, expected repair costs during the term of the warranty can be determined and, based on the expected costs, a purchase price of the warranty plan can be set.

According to one aspect of the invention, there is provided a system and method for quoting a purchase price of a vehicle warranty plan, including obtaining vehicle characteristic data based on a vehicle characteristic identifier; automatically decoding the vehicle characteristic data to determine a vehicle configuration and/or a vehicle status; and quoting a purchase price of the warranty plan based on the vehicle configuration and/or the vehicle status.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 illustrates an exemplary system for quoting a warranty purchase price in accordance with the invention.

FIG. 2 is a block diagram of an exemplary computer and/or server that can be used in the system of FIG. 1.

FIG. 3 is a flow chart illustrating steps for performing an exemplary method in accordance with the invention.

FIGS. 4A-4C are screen snapshots of an exemplary interface for obtaining a warranty purchase price quote.

### DETAILED DESCRIPTION OF EMBODIMENTS

The present invention will now be described with reference to the drawings, wherein like reference numerals are used to refer to like elements throughout. The invention will be described primarily in the context of an extended warranty plan for an automobile. However, it will be appreciated that the invention is not intended to be limited to automobile warranties, and may be utilized with warranties for other vehicles, including trucks, motor homes, busses, tractors, boats, motorcycles, campers, trailers, etc.

The present invention provides a system and method that enables a purchase price of a vehicle extended warranty plan to be accurately, quickly and easily quoted. Moreover, the purchase price may be quoted from the convenience of one's home, office, etc., without first consulting a sales representative. As a result, sales of warranty plans are likely to increase since prospective warranty purchasers can directly obtain a quote, without having to travel or call a sales representative.

In quoting a purchase price of the warranty plan, vehicle data may be obtained via a characteristic identifier, wherein the vehicle data can provide information indicative of characteristics of the vehicle. Preferably, the characteristic identifier uniquely identifies the vehicle. The characteristic identifier, for example, may include numbers and/or letters (e.g., it may be a numeric identifier, an alphabetic identifier, or an alpha-numeric identifier).

As described herein, the characteristic identifier may be any identifier that can provide characteristic information for the vehicle. One such identifier is the vehicle identification number or VIN. Generally, the VIN of modern vehicles is a seventeen digit number that sets the vehicle apart from the millions of vehicles produced every year. The VIN displays a car's uniqueness and heritage and provides a form of identification. Each character or digit in the VIN has a particular purpose.

The 1st character identifies the country in which the vehicle was manufactured. For example: U.S.A.(1or4), Canada(2), Mexico(3), Japan(J), Korea(K), England(S), Germany(W), Italy(Z). The 2nd character identifies the manufacturer, such as, for example, Audi(A), BMW(B), Buick(4), Cadillac(6), Chevrolet(1), Chrysler(C), Dodge(B), Ford(F), GM Canada(7), General Motors(G), Honda(H), Jaguar(A), Lincoln(L), Mercedes Benz(D), Mercury(M), Nissan(N), Oldsmobile(3), Pontiac(2or5), Plymouth(P), Saturn(8), Toyota(T), VW(V), Volvo(V). The 3rd character identifies vehicle type or manufacturing division, while the 4th to 8th characters identifies vehicle features such as body style, engine type, model, series, etc. The 9th character identifies VIN accuracy as check digit.

The 10th character identifies the model year. For example: 1988(J), 1989(K), 1990(L), 1991(M), 1992(N), 1993(P), 1994(R), 1995(S), 1996(T), 1997(V), 1998(W), 1999(X), 2000(Y) . . . 2001(1), 2002(2), 2003(3). The 11th character identifies the assembly plant for the vehicle, and the 12th to 17th characters identifies the sequence of the vehicle for production as it rolled of the manufacturers assembly line.

The characteristic identifier (e.g., the VIN) can be used to access a database or the like. In a preferred embodiment of the invention, the database is maintained by a third party not affiliated with the warranty provider. As will be appreciated, however, the database may be maintained by the warranty provider and/or by a third party that is affiliated with the warranty provider.

Using the characteristic identifier, characteristic information of the vehicle can be retrieved from the database and then decoded to ascertain features, options, configurations, and/or other pertinent vehicle information. Moreover, information above and beyond what is obtainable from simply decoding the VIN can be stored in the database. For example, for each characteristic identifier, information relating to non-production data may be stored in and retrievable from the database. As used herein, non-production data refers to vehicle information that cannot be obtained from the manufacturer's production records, including the VIN. For example, non-production data may include dealer installed options, collision history, flood damage, repair history, previous insurance claims, etc. These features, configurations, options, non-production data, etc. then can be used to determine failure rates of components and expected repair costs associated with such failures. Based on this information, a purchase price of the warranty plan can be quoted.

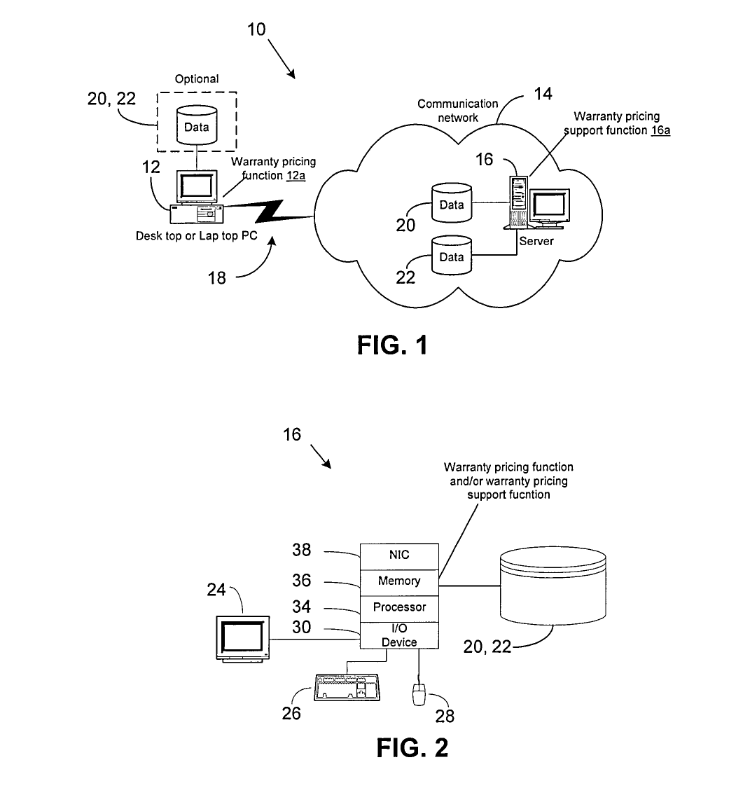

Referring initially to FIG. 1, there is shown an exemplary system 10 for carrying out a method for providing vehicle warranty pricing and enrollment. A computer 12 (e.g., a PC or the like) may be configured to operate as part of the system 10, and may include a warranty pricing function 12a, which is discussed in more detail below. The system 10 may include a communications network 14 having a server 16 (or servers) for receiving characteristic identifiers, transmitting vehicle data to the computer 12, and carrying out any other support functions. The server can communicate with the computer 12 via a transmission medium 18. The server 16 may include a warranty pricing support function 16a, which also is described in more detail below.

The transmission medium 18 may be any appropriate device or assembly, including, for example, a communication network such as the Internet, a LAN, a WAN, etc. Portions of the network may include wireless transmission pathways. The network 16 may support the communications activity of multiple computers 12, although only one computer 12 is shown in the illustration of FIG. 1.

The server 16 may include or have access to one or more databases. A first database 20, for example, can include a plurality of characteristic identifiers (e.g., a plurality of VIN's), and corresponding data that includes characteristics of the vehicle identified by the characteristic identifier. The server 16 also may include a second database 22, wherein the second database 22 includes statistical information relating to component failure rates for a number of different vehicles. Further, the second database 22 can include information relating to repair costs for various components of different vehicles.

It is noted that the first and second databases 20 and 22, although shown on the server 16, also may reside on the computer 12. In such a configuration, the computer 12 may periodically (e.g., once a day) check for updates to each database 20 and 22 (e.g., connect to the server 16 and download the latest updates, and then disconnect from the server 16). An advantage of this configuration is that the computer 12 does not need a network connection in order to provide warranty pricing information. For example, a sales representative can provide warranty pricing information even when an internet or other network connection is not available.

In one embodiment, the server 16 may operate in stand alone configuration relative to other servers of the network 14 or may be configured to establish multiple communications sessions with other servers (not shown). As will be appreciated, the server 16 may be configured as a typical computer system used to carry out server functions and may include a processor configured to execute software containing logical instructions that embody the functions of the server 16. Those functions may include functions that are complimentary to the operation of the warranty pricing feature discussed herein.

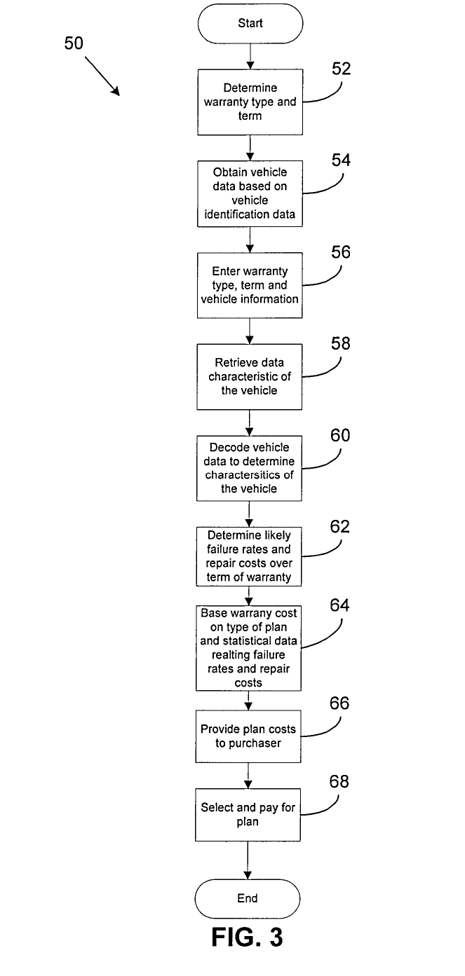

With further reference to FIG. 2, there is shown a block diagram of the exemplary server 16. As will be appreciated, the block diagram of FIG. 2 also is applicable to the computer 12. The server 16 may include a display 24 for viewing system information, and a keyboard 26 and pointing device 28 for data entry, screen navigation, etc. A computer mouse or other device that points to or otherwise identifies a location, action, etc., e.g., by a point and click method or some other method, are examples of a pointing device 28. Alternatively, a touch screen (not shown) may be used in place of the keyboard 26 and pointing device 28. The display 24, keyboard 26 and mouse 28 communicate with a processor via an input/output device 30, such as a video card and/or serial port (e.g., a USB port or the like).

A processor 34, such as an AMD Athlon 64® processor or an Intel Pentium IV® processor, combined with a memory 36 execute programs to perform various functions, such as data entry, numerical calculations, screen display, system setup, etc. The memory 36 may comprise several devices, including volatile and non-volatile memory components. Accordingly, the memory 36 may include, for example, random access memory (RAM), read-only memory (ROM), hard disks, floppy disks, optical disks (e.g., CDs and DVDs), tapes, flash devices and/or other memory components, plus associated drives, players and/or readers for the memory devices. The processor 34 and the memory 36 are coupled using a local interface (not shown). The local interface may be, for example, a data bus with accompanying control bus, a network, or other subsystem.

The memory may form part of a storage medium for storing information, such as application data, screen information, programs, etc., part of which may be in the form of a database (e.g., databases 20 and 22). The storage medium may be a hard drive, for example, or any other storage means that can retain data, including other magnetic and/or optical storage devices. A network interface card (NIC) 38 allows the server 16 to communicate with external devices (e.g., the computer 12).

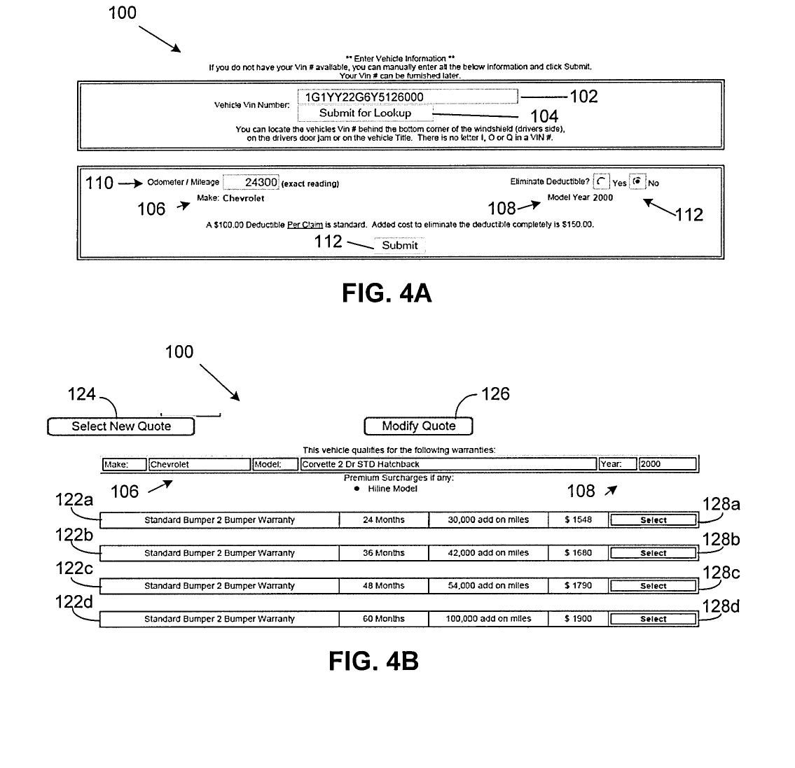

Referring to FIG. 3, a method 50 of quoting warranty pricing is depicted. The exemplary method 50 of FIG. 3 illustrates how pricing for an automobile extended warranty plan may be implemented. It will be appreciated that the method may be adapted to other goods and/or vehicles, including, for example, trucks, busses, motorcycles, etc. Portions of the functionality of the method may be carried out by the computer 12 (e.g., the warranty pricing function 12a) and portions of the functionality of the method may be carried out by the server 16 (e.g., the warranty pricing support function 16a). Alternatively, the functions may be performed on a single computer (e.g., the warranty pricing function 12a and warranty pricing support function 16a may reside on the computer 12 and/or the server 16). The functionality of the method may be embodied as executable code, such as in the form of the warranty pricing function 12a and/or the warranty pricing support function 16a, or any other suitable form, including software, firmware, dedicated circuit components, a program stored on a computer readable media or in machine usable medium, and so forth.

Although the illustrated method shows a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

The method may begin in block 52, wherein the type of warranty plan is determined or otherwise selected. For example, a potential purchaser of the warranty plan may be presented with several options. These options may include a deductible level (e.g., how much will the vehicle owner be required to pay before the warranty takes effect), a coverage level (e.g., what components are or are not covered by the plan), and/or a term of the plan (e.g., how long will the plan be in effect).

The deductible dictates the out-of-pocket expense incurred by the warranty holder before the warranty plan will begin to provide benefits. For example, if a warranty plan includes a $250 deductible, and the repair cost is $450, then the warranty holder will be compensated the difference between the actual cost and the deductible ($200 in this example). As will be appreciated, warranty plans with lower deductibles generally will have a higher purchase price.

Another option for the potential purchaser to determine is the amount of coverage of the warranty plan. For example, the potential purchaser may want all problems with the vehicle to be covered by the plan. In this case, the potential purchaser would be interested in a bumper-to-bumper plan, wherein all non-wear related items are covered by the plan (items such as brake, tires batteries, etc. typically are not covered by such plans). Instead of a bumper-to-bumper warranty plan, the potential purchaser may elect for a plan that covers the drive train (e.g., the engine, transmission, rear end, etc.). As will be appreciated, the bumper-to-bumper plan generally is priced higher than a drive train warranty plan (or other plan that does not cover all non-wear related components of the vehicle).

Yet another option is the term of the warranty plan. The warranty term may be defined with respect to time, use, or both. For example, the warranty may be for three years, with no mileage restriction. Alternatively, the warranty plan may use a combination of time and use, e.g., three years or 36,000 miles, whichever occurs first. As will be appreciated, long term/use plans tend to be higher in price than short term/use plans.

Moving now to block 54, a characteristic identifier of the vehicle is obtained. Preferably, the characteristic identifier is a unique characteristic identifier, such as the vehicle identification number or VIN, although other characteristic identifier also may be used. For example, instead of the VIN, a serial number may be used, provided the serial number can identify characteristics of the vehicle. As will be appreciated, any means of identifying the vehicle may be employed, provided the identification means enables characteristics of the vehicle to be identified.

Once the warranty type has been determined and the vehicle characteristic identifier has been obtained, they are entered into the computer 12 as indicated at block 56. Depending on the location of the database 20, one of several different steps may occur. If the database 20 resides on the computer 12, then at block 58 the computer 12 proceeds to search for the characteristic identifier in the database 20 and, when found, retrieves data corresponding to that identifier. Alternatively, if the database 20 resides on the server 16, then at block 58 the computer 12, via communications network 14 and transmission medium 18, establishes a communication link with the server 16. Through the communication link, the characteristic identifier is provided to the server 16, which then proceeds to search for the characteristic identifier in the database 20. When the characteristic identifier is found, data corresponding to the characteristic identifier is extracted and then provided back to the computer 12.

The extracted data from the database 20 may be in the form of codes that appear meaningless to the casual observer. However, these codes can identify features, configurations and/or non-production data of the vehicle. The computer 12 can be configured to decode the characteristic data into meaningful information. For example, the code 1A may correspond to an automatic transmission, while the code 1B may correspond to a manual transmission. Similarly, the code 2A may correspond to a hard top vehicle, while 2B may correspond to a convertible top vehicle. Regarding non-production data, the code 3A may signify that the vehicle was in a major accident and certain components were subsequently repaired.

At block 60, the computer 12 decodes the data so as to determine a configuration and/or a status of the vehicle. Characteristics of interest in determining warranty pricing may include, for example, vehicle type (e.g., car, truck, motorcycle, etc.), engine configuration (e.g., 4, 6, 8, 10 cylinder), engine size (e.g., cubic inches), engine induction (e.g., normally aspirated, forced induction), transmission configuration (e.g., automatic, manual), vehicle class (e.g., economy, luxury, sport, sport-utility), body style (e.g., hard top, convertible, targa top), power train configuration (e.g., two-wheel drive, four-wheel drive, all-wheel drive), or any other characteristic that may be of interest when determining repair costs of a vehicle. Status information of interest may include previous collisions/repairs, flood/water damage, etc.

Once the characteristic features of the vehicle in question have been determined, expected failure rates and corresponding repair costs for these features over the warranty term are estimated, as indicated at block 62. These failure rates and costs can be estimated, for example, based on statistical analysis of a priori information related to failure rates and repair costs for similar vehicles. The statistical data, which may be stored in the second database 22, can include likely failure rates of vehicle components, and estimated repair costs for the vehicle components. If the second database 22 resides on the computer 12, it can directly access the second database 22 to retrieve the failure rate data and repair cost data. If the second database 22 resides on the server 16 (or at some other location), the computer 12 can establish a communication link to the server 16 (or other device), which then proceeds to find, retrieve and communicate that data back to the computer 12. Using the statistical data, the computer 12 can calculate a purchase price of the warranty plan via conventional statistical computations, as indicated at block 64.

At block 66, the purchaser may be provided with a number of plans in which to choose from, and the corresponding purchase price for the plans. At block 68, the purchaser then may choose one of the plans (e.g., by clicking on a soft button or the like), which can direct the purchaser to a purchase interface (e.g., a web-based payment system). The purchaser then may pay for the warranty plan via credit card, debit card, electronic transfer, or any other electronic payment means. Alternatively, the purchaser may pay for the plan via a money order, personal check, etc. The warranty plan may take effect upon receipt of payment or upon acceptance of the payment plan by the purchaser.

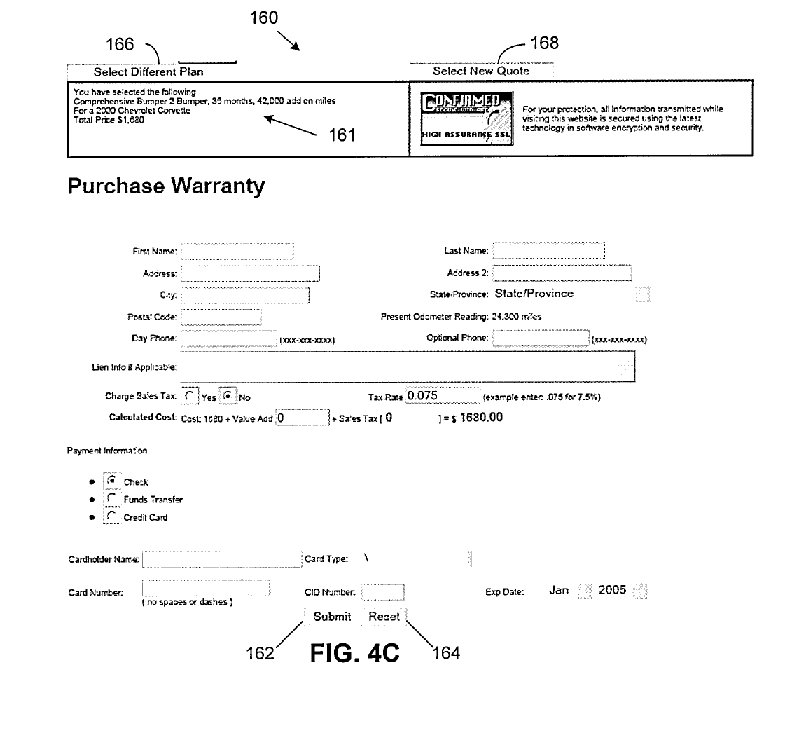

FIGS. 4A-4C illustrate screen shots of an exemplary interface in accordance with the invention. Beginning with FIG. 4A, there is shown an introductory screen 100, wherein a first entry 102 accepts a characteristic identifier of the vehicle, such as the VIN, for example. Upon entering the characteristic identifier, the user may click or otherwise select the Submit for Lookup button 104, which initiates a search into the first database 20, and then retrieval of characteristic data for the vehicle. That data may be partially decoded to display certain features of the vehicle (e.g., the make 106, model year 108). As will be appreciated, additional characteristic information may be displayed for the vehicle, if desired.

Also included on the introductory screen 100 is a use entry 110 for identifying a level of use of the vehicle. In the case of an automobile, for example, the use entry 110 may be an odometer reading (e.g. mileage) from the vehicle. As will be appreciated, other means for measuring vehicle use may be implemented without departing from the scope of the invention. For example, an hour meter may be used to measure vehicle use instead of an odometer.

Further, the introductory screen 100 may include a deducible selection 112, wherein the user may choose to include or to not include a deductible with the warranty plan. Although not shown, further selections with respect to the deductible may be included. For example, there may be an entry for the amount of the deductible (e.g., a selection for a $250 deductible, a selection for a $500 deductible, etc.). Once the user has entered the relevant information, he may click or otherwise select the Submit button 112.

The Submit button 112 can initiate the analysis of the data (e.g. analysis of the characteristic data of the automobile as retrieved from the first database 20, and analysis of failure rates and repair costs for various components based on data from the second database 22) and generate a pricing quote, which then may be provided to the user. FIG. 4B illustrates an exemplary quote screen 120. From the quote screen 120, the user can review the pricing quotes 122a-122d for various warranty plans. In the exemplary quote screen of FIG. 4B, four different bumper-to-bumper quotes are provided, wherein each quote is for a different term (e.g., 24/30, 36/42, 48/54 and 60/100). The user may select a new quote (e.g., change the vehicle for which a warranty plan is desired) via the Select New Quote button 124 or modify the present quote (e.g., change one or more parameters for the present vehicle) via the Modify Quote button 126. If the quote is acceptable to the user, he may click or otherwise select one of the select buttons 128a-128d that corresponds to one of the quoted warranties.

Once the user selects one of the warranties via the select buttons 128a-128d, he may be prompted to purchase the warranty plan. FIG. 4C illustrates an exemplary purchase screen 160, which can include a vehicle summary display 161 that indicates which vehicle the warranty quote pertains and the warranty plan that was selected. The purchase screen 160 includes a number of conventional fields for making an on-line or electronic payment. Such fields are well known in the art and will not be described herein. The user may enter the requested information and the click or otherwise select the Submit button 162, which will execute the payment. If the user wishes to clear all entered data and begin from scratch, he may click or otherwise select the Reset button 164, which will clear all payment fields.

Alternatively, the user may wish to select a completely different plan. For example, the user may have selected a plan that had a 48 month term, when he meant to select a plan with a 36 month term. To change the plan, the user may click or otherwise select the Select Different Plan button 166, which will display the quote screen of FIG. 4B, from which the user can select a different plan. If the user wishes to change the vehicle for which a warranty plan is desired, then the user may select the Select New Quote button 168, which will display the introductory screen 100 of FIG. 4A and allow the user to start a new quote process.

Accordingly, a system and method for quickly, easily and accurately providing a purchase price quote for an extended warranty plan has been described. The system and method enable an individual to quickly compare a number of different warranty types for a number of different vehicles in a relatively short time period. Moreover, contact with a sales representative is not necessary. This increases the likelihood that individuals who avoid sales representatives will actually review and possibly purchase the warranty plan.

A person having ordinary skill in the art of computer programming and applications of programming for computer systems would be able in view of the description provided herein to program a computer 12 and/or server 16 to operate and to carry out the functions described herein. Accordingly, details as to the specific programming code have been omitted for the sake of brevity. Also, while software in the memory 36 or in some other memory of the computer and/or server may be used to allow the system to carry out the functions and features described herein in accordance with the preferred embodiment of the invention, such functions and features also could be carried out via dedicated hardware, firmware, software, or combinations thereof, without departing from the scope of the invention.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of transacting business in conjunction with the sale of vehicle warranty plans, comprising:
obtaining vehicle characteristic data based on a vehicle characteristic identifier;
automatically decoding the vehicle characteristic data to determine a vehicle configuration and/or a vehicle status; and
quoting a purchase price of a warranty plan based on the vehicle configuration and/or the vehicle status.

2. The method of claim 1, wherein obtaining vehicle characteristic data includes accessing at least one server on a network to retrieve the vehicle characteristic data.

3. The method of claim 1, wherein quoting includes determining expected vehicle repair costs over a term of the warranty plan.

4. The method of claim 3, wherein determining expected vehicle repair costs includes using statistical analysis to determine component failure rates over the term of the warranty.

5. The method of claim 4, wherein determining expected repair costs includes identifying repair costs for components that are likely to fail over the warranty term.

6. The method of claim 1, wherein obtaining vehicle characteristic data includes using a vehicle characteristic identifier that uniquely identifies the vehicle.

7. The method of claim 1, wherein obtaining vehicle characteristic data includes using at least one of a vehicle identification number or a vehicle serial number as the vehicle characteristics identifier.

8. The method of claim 1, wherein decoding includes determining at least one of a vehicle model year, a vehicle make, a vehicle model, a vehicle type, a vehicle class, a vehicle engine size, a vehicle engine configuration, a vehicle drive train configuration, a vehicle body style, or a vehicle performance characteristic.

9. The method of claim 1, wherein quoting includes using at least one of a term of the warranty plan, a deductible of the warranty plan, or a coverage level of the warranty plan to quote a purchase price of the warranty plan.

10. The method of claim 9, wherein the coverage level is at least one of a drive train coverage plan or a bumper-to-bumper coverage plan.

11. The method of claim 1, wherein obtaining vehicle characteristic data includes obtaining data corresponding to non-production data for the vehicle.

12. A system for quoting a vehicle warranty purchase price, comprising:
a processor and memory;
warranty quoting logic stored in memory and executable by the processor, said warranty quoting logic comprising:
logic that obtains vehicle characteristic data based on a vehicle characteristic identifier;
logic that automatically decodes the vehicle characteristic data to determine a vehicle configuration and/or a vehicle status; and
logic that quotes a purchase price of a warranty plan based on the vehicle configuration and/or the vehicle status.

13. The system of claim 12, wherein the logic that obtains vehicle characteristic data includes logic that accesses at least one server on a network to retrieve the vehicle characteristic data.

14. The system of claim 12, wherein logic that quotes includes logic that determines expected vehicle repair costs over a term of the warranty plan.

15. The system of claim 14, wherein logic that determines expected vehicle repair costs includes logic that uses statistical analysis to determine component failure rates over the term of the warranty.

16. The system of claim 15, wherein logic that determines expected repair costs includes logic that identifies repair costs for components that are likely to fail over the warranty term.

17. The system of claim 12, wherein logic that obtains vehicle characteristic data includes logic that uses a vehicle characteristic identifier that uniquely identifies the vehicle.

18. The system of claim 12, wherein logic that obtains vehicle characteristic data includes logic that uses at least one of a vehicle identification number or a vehicle serial number as the vehicle characteristics identifier.

19. The system of claim 12, wherein logic that decodes includes logic that determines at least one of a vehicle model year, a vehicle make, a vehicle model, a vehicle type, a vehicle class, a vehicle engine size, a vehicle engine configuration, a vehicle drive train configuration, a vehicle body style, or a vehicle performance characteristic.

20. The system of claim 12, wherein logic that quotes includes logic that uses at least one of a term of the warranty plan, a deductible of the warranty plan, or a coverage level of the warranty plan to quote a purchase price of the warranty plan.

21. The system of claim 12, wherein logic that obtains vehicle characteristic data includes obtaining data corresponding to non-production data for the vehicle.

22. A computer program embodied on a computer readable medium for quoting a purchase price of a warranty plan, comprising:
code that obtains vehicle characteristic data based on a vehicle characteristic identifier;
code that decodes the vehicle characteristic data to determine a vehicle configuration and/or a vehicle status; and
code that quotes a purchase price of a warranty plan based on the vehicle configuration and/or the vehicle status.
